(19) United States
(12) Patent Application Publication
(10) Pub. No.: US 2026/0280942 A1
(43) Pub. Date: Sep. 17, 2026

(54) WIRELESS COMMUNICATION DEVICE, WIRELESS COMMUNICATION SYSTEM, COMMUNICATION CONTROL METHOD, AND NON-TRANSITORY COMPUTER-READABLE MEDIUM

(71) Applicant: NEC Corporation, Tokyo (JP)

(72) Inventor: Noriaki TAWA, Tokyo (JP)

(73) Assignee: NEC Corporation, Tokyo (JP)

(21) Appl. No.: 19/551,770

(22) Filed: Feb. 27, 2026

(30) Foreign Application Priority Data
Mar. 11, 2025 (JP) 2025-038563

(51) Int. Cl. H04L 25/02; H04L 27/26

(52) U.S. Cl. CPC H04L 25/0228; H04L 27/2639

(57) ABSTRACT

A wireless communication device includes a memory configured to store instructions, and a processor configured to execute the instructions to receive an orthogonal time frequency space (OTFS) signal from a communication target, estimate an entire spread of a pilot signal of the OTFS signal by using data near a center of the pilot signal, extrapolate a reference signal (CIR-RS) by using a result of the estimation, and perform channel estimation with the extrapolated signal.

### INCORPORATION BY REFERENCE

This application is based upon and claims the benefit of priority from Japanese patent application No. 2025-038563, filed on Mar. 11, 2025, the disclosure of which is incorporated herein in its entirety by reference.

### TECHNICAL FIELD

The present disclosure relates to a wireless communication device, a wireless communication system, a communication control method, and a communication control program.

### BACKGROUND ART

It has been studied that, in a wireless base station device, large-capacity communication is performed also for user equipment (UE) that moves at a high speed.

However, orthogonal frequency division multiplexing (OFDM) modulation schemes used in the fourth generation (4G) and the fifth generation (5G) have a problem that robustness to a frequency error due to a Doppler effect or the like is low. In particular, in recent years, use of a high frequency band such as a millimeter wave greatly affected by the Doppler effect has been studied, and it has been important to increase robustness to the Doppler effect.

In order to correct the Doppler effect by the OFDM, it is necessary to increase the number of reference signals and frequently update and correct a channel estimation result. However, in a case where the number of reference signals is increased, the number of elements that can be used for data communication decreases, and a data rate lowers. Since the channel estimation result is frequently updated, there has been a problem that an amount of calculation of a data processing unit increases.

Therefore, in recent years, there has been proposed an orthogonal time frequency space (OTFS) modulation scheme (R. Hadani et al., “Orthogonal Time Frequency Space Modulation”, 2017 IEEE Wireless Communications and Networking Conference (WCNC), 2017, pp. 1-6). In the OTFS, transmission data is not arranged in a time-frequency (TF) space as in the OFDM, but is arranged in a delay-Doppler (DD) space.

Therefore, it is expected that robustness to a frequency error due to the Doppler effect is strong and high-speed communication becomes possible even for a high-speed mobile body.

### SUMMARY

In an orthogonal time frequency space (OTFS) signal, a pulse-shaped pilot signal is generally used for channel estimation, but it is known that the pilot signal is greatly spread in the delay-Doppler (DD) space due to propagation.

In order to perform the channel estimation from such a pilot signal, it is necessary to extract the pilot signal from a wide range of the DD space, and it is necessary to provide, around the pilot signal, a guard space in which no signal is arranged.

A user signal is arranged outside the guard space.

Since the user signal spreads in the DD space due to propagation similarly to the pilot signal, in a case where the guard space is narrow, the pilot signal and the user signal interfere with each other. In a case where the interference occurs, the channel estimation cannot be accurately performed, and accuracy of a demodulation signal decreases.

On the other hand, in a case where the guard space is widened, there has been a problem that the DD space in which the user signal is arranged is reduced and a throughput is lowered. Therefore, an example object of the present disclosure is to provide a wireless communication device and the like that enable both a high throughput and high-accuracy reception by extrapolating a reference signal in an OTFS signal.

A wireless communication device of an example aspect of the present disclosure is a wireless communication device including
a memory that stores a program, and
a processor that processes the program that
receives an orthogonal time frequency space (OTFS) signal from a communication target,
estimates an entire spread of a pilot signal of the OTFS signal by using data near a center of the pilot signal,
extrapolates a reference signal (channel impulse response reference signal (CIR-RS)) by using a result of the estimation, and
performs channel estimation with the extrapolated signal.

A wireless communication system of an example aspect of the present disclosure is a wireless communication system including
a communication target that transmits an orthogonal time frequency space (OTFS) signal, and
a wireless communication device including a memory that stores a program, and a processor that processes the program that receives the OTFS signal from the communication target, estimates an entire spread of a pilot signal of the OTFS signal by using data near a center of the pilot signal, extrapolates a reference signal (channel impulse response reference signal (CIR-RS)) by using a result of the estimation, and performs channel estimation with the extrapolated signal.

A communication control method of an example aspect of the present disclosure is a communication control method including
receiving an orthogonal time frequency space (OTFS) signal from a communication target,
estimating an entire spread of a pilot signal of the OTFS signal by using data near a center of the pilot signal,
extrapolating a reference signal (CIR-RS) by using a result of the estimation, and
performing channel estimation with the extrapolated signal.

A non-transitory computer-readable medium storing a communication control program of an example aspect of the present disclosure is a non-transitory computer-readable medium storing a communication control program for causing an information processing device to execute
receiving an orthogonal time frequency space (OTFS) signal from a communication target,
estimating an entire spread of a pilot signal of the OTFS signal by using data near a center of the pilot signal,
extrapolating a reference signal (CIR-RS) by using a result of the estimation, and
performing channel estimation with the extrapolated signal.

According to an example advantage of the present disclosure, by using the data near the center of the received pilot signal, distribution of the pilot signal in a region away from the center is extrapolated. As a result, it is possible to perform highly accurate channel estimation in a narrow guard space, and to improve a throughput.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an outline of a wireless communication system according to the present disclosure;

FIG. 2 is a block diagram illustrating a base station reception unit according to the present disclosure;

FIG. 3 is a diagram illustrating details of a channel estimation unit according to the present disclosure;

FIG. 4 is a diagram illustrating arrangement of various signals in a DD space for an OTFS signal according to the present disclosure;

FIG. 5 is a diagram illustrating power distribution of a signal measured under a Doppler environment according to the present disclosure;

FIG. 6A is a diagram illustrating comparison between a measurement result and amplitude modeled in a method of the present disclosure in a symbol according to the present disclosure;

FIG. 6B is a diagram illustrating comparison between the measurement result and a phase modeled in the method of the present disclosure in the symbol according to the present disclosure;

FIG. 7 is a diagram illustrating comparison of EVM between a case where an extrapolation method according to the present disclosure is used and a case where the extrapolation method is not used;

FIG. 8A is a diagram illustrating amplitude of an extrapolation result in a symbol direction according to the present disclosure;

FIG. 8B is a diagram illustrating a phase of the extrapolation result in the symbol direction according to the present disclosure; and

FIG. 9 is a block diagram illustrating a configuration of an information processing device according to the present disclosure.

### EXAMPLE EMBODIMENTS

### First Example Embodiment

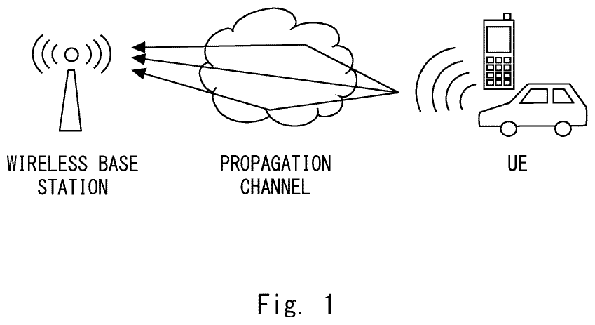

FIG. 1 illustrates an outline of a wireless communication system. This is a diagram representing communication between a wireless base station to which the present disclosure is applied and user equipment (UE). The UE transmits an uplink signal to the wireless base station while being moved by a user.

An OTFS-modulated high-frequency transmission signal including a pilot signal is transmitted from the UE.

This transmission signal is subjected to a Doppler effect because the user is moving. A distance between the base station and the UE continuously changes, and a delay amount also changes.

Under such an environment, the pilot signal included in the OTFS signal received by the base station is greatly spread in a DD space and received.

Therefore, the entire spread of the pilot signal is estimated using data near a center of the pilot signal. As a result, channel estimation can be accurately performed even with the OTFS signal for which a guard space is set to be narrow.

In the present example embodiment, the uplink signal is assumed, but use for a downlink signal is also possible. In that case, a base station reception unit to be described later is a UE reception unit.

### (Description of Configuration of Wireless Communication Device According to First Example Embodiment)

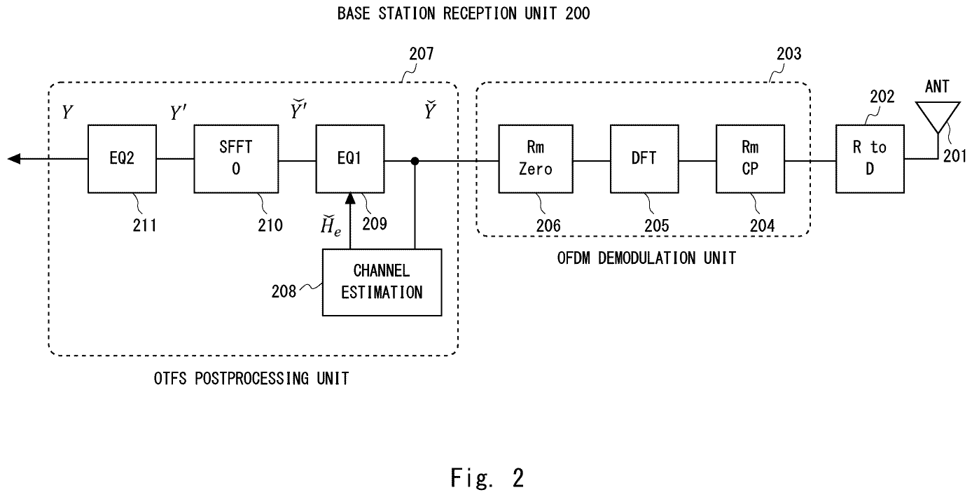

FIG. 2 illustrates a block diagram of the base station reception unit according to the present disclosure. A base station reception unit 200 includes an ANT unit 201 as an antenna, an R to D unit 202 that converts a received radio frequency (RF) signal into a digital signal, an OFDM demodulation unit 203, and an OTFS postprocessing unit 207.

Similarly to a conventional OFDM demodulation function unit, the OFDM demodulation unit 203 includes an Rm CP unit 204 that removes a cyclic prefix (CP), a DFT unit 205 that performs discrete Fourier transform, and an Rm Zero unit 206 that removes out-of-band components.

The OTFS postprocessing unit 207 includes a channel estimation unit 208 that estimates a propagation channel, a first equalizer EQ1 (209), an SFFT0 unit 210 that performs symplectic finite Fourier transform (SFFT), and a second equalizer EQ2 (211).

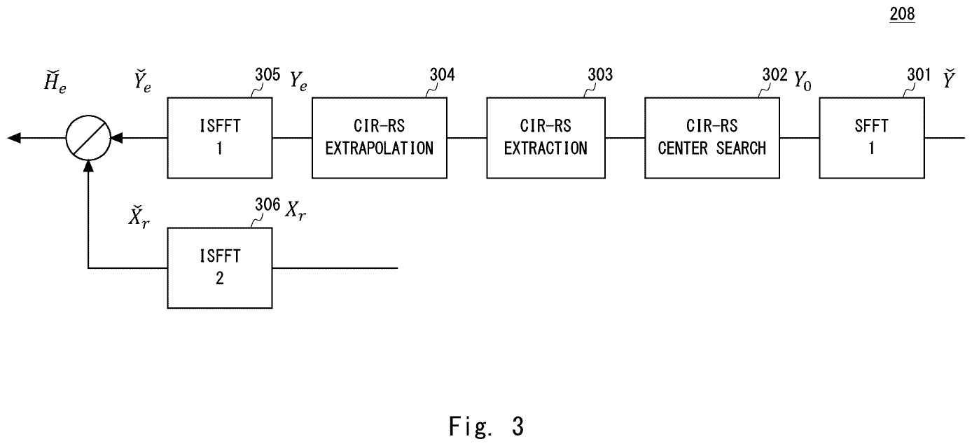

FIG. 3 illustrates details of the channel estimation unit 208.

The channel estimation unit 208 includes an SFFT1 unit 301 that performs the SFFT, a channel impulse response reference signal (CIR-RS) center search unit 302 that finds a center position of a CIR-RS of a reception unit, a CIR-RS extraction unit 303 that extracts an element region around the CIR-RS, a CIR-RS extrapolation unit 304 that extrapolates the CIR-RS, an ISFFT1 unit 305 that performs inverse SFFT (ISFFT), and an ISFFT2 unit 306 that performs the ISFFT on a reference signal.

(Description of Communication Control Method of Wireless Communication Device according to First Example Embodiment)

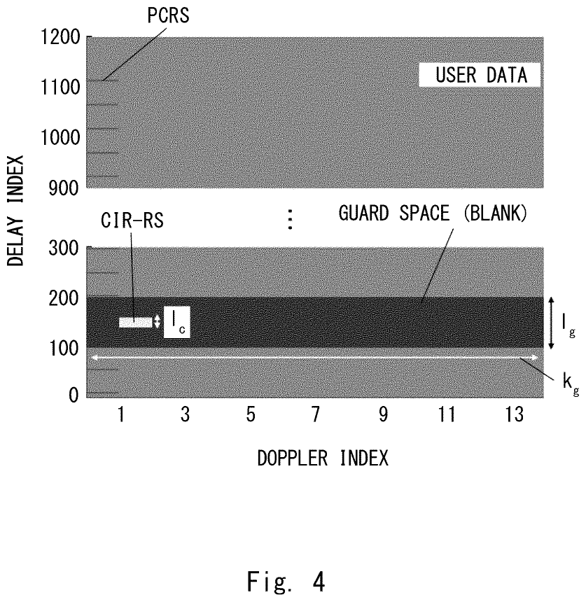

FIG. 4 illustrates arrangement of various signals in the DD space for the OTFS signal according to the present disclosure. A data set of FIG. 4 is set as one subframe. The channel estimation unit 208 estimates the entire spread of the pilot signal of the OTFS signal by using the data near the center of the pilot signal.

In FIG. 4, a vertical direction is represented by a delay index 1, and a horizontal direction is represented by a Doppler index k. The vertical direction is also referred to as a subcarrier, and the horizontal direction is also referred to as a symbol. l and k are l=0, 1, . . . , M−1, and k=0, 1, . . . , N−1, and are set as M=1200 and N=14 in the first example embodiment.

In the first example embodiment, user data, an impulse response measurement reference signal (CIR-RS), and a phase compensation reference signal (PCRS) are included in the one subframe.

The CIR-RS is arranged at the Doppler index k=k₀=1, centered at the delay index l=l₀=149. A signal length of the CIR-RS on the delay index is set as l_{c}=19 subcarriers. Channel estimation is performed using the CIR-RS.

A guard space is arranged around the CIR-RS. The guard space is blank (zero data). The number of subcarriers of the guard space is set as l_{g}=101, and the number of symbols is set as k_{g}=14.

A base station receiver receives an RF signal transmitted from the UE by the ANT unit, and converts the RF signal received in the R to D unit into a digital baseband signal.

The OFDM demodulation unit 203 performs OFDM demodulation by a known method. First, a CP is removed from the received digital baseband signal. Thereafter, Fourier transform is performed and out-of-band components are removed. As a result, reception data
[symbol] in a time-frequency (TF) space is obtained.
[symbol] is an M×N complex matrix.

Next, the reception data [symbol]
is input to the channel estimation unit 208 of the OTFS postprocessing unit 207.

The reception data input to the channel estimation unit 208

[symbol]

is subjected to SFFT transform by the SFFT1 unit 301, and converted into a signal Y₀ in the DD space. The signal Y₀ is also an M×N complex matrix. Each element of Y₀ is represented as y₀(l, k).

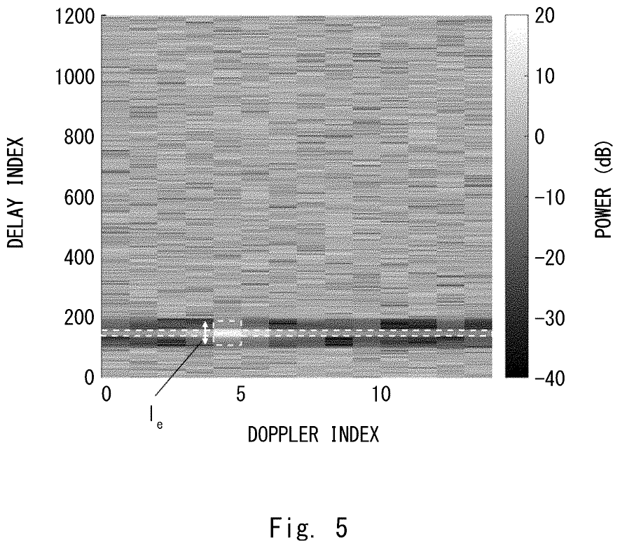

FIG. 5 illustrates power distribution of the signal Y₀ measured under a Doppler environment. This is a measurement value in a case where a Doppler shift related to 500 km/h is given under a multipath environment in a carrier wave of 28 GHz. At the time of UE transmission, the CIR-RS is arranged at the Doppler index k=1 as illustrated in FIG. 4, but is shifted to k=4 by the Doppler shift. It can be seen that a CIR-RS response greatly spreads in a delay index direction and a Doppler index direction due to delay due to propagation and the Doppler shift.

The channel estimation unit 208 first obtains a center position of the CIR-RS from amplitude distribution of the reception signal Y₀. In the first example embodiment, since the CIR-RS is arranged at the plurality of consecutive subcarriers, it is difficult to determine the center with a single subcarrier amplitude. Therefore, a moving average method is used to search for the center position in the delay direction. In the first example embodiment, the number of samples in the moving average method is set as 19 subcarriers equal to the signal length l_{c} of the CIR-RS. A sample range of the moving average method is set as ±9 subcarriers centered at the subcarriers to be searched, and a center subcarrier with a highest moving average value is set as the center position in the delay direction of the CIR-RS.

In the first example embodiment, since a symbol length of the CIR-RS is set to 1, a moving average is not used in the Doppler direction, and a symbol having a maximum amplitude is regarded as the center. In a case where the symbol length of the CIR-RS is set as equal to or more than 2, the moving average is used.

As a result, the center in FIG. 5 is

$$( l , k ) = ( {\overline{l}}_{0} , {\overline{k}}_{0} ) = ( 149 , 4 )$$

Next, a region surrounded by a white dotted line in FIG. 5 is extracted as data used for the channel estimation. As a size of the region, in the case of

$$k = {\overline{k}}_{0}$$

lₑ=81 subcarriers are extracted in the delay index direction centered at

### To

In other symbols

$$( k \neq {\overline{k}}_{0} )$$

l_{c} subcarriers are extracted in the delay index direction centered at
l̅₀

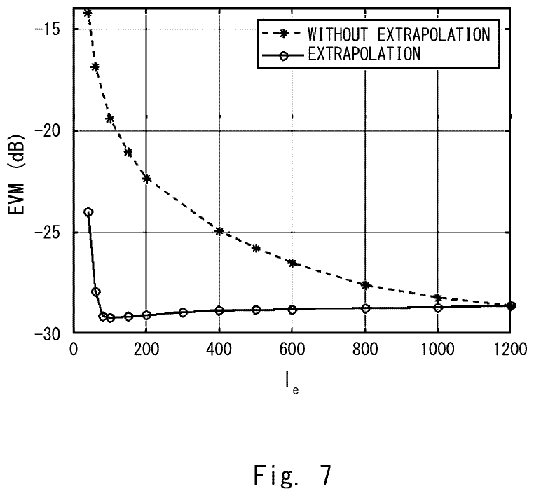

The subcarrier extraction range lₑ=81 is selected as a value at which error vector magnitude (EVM) is the lowest from a correlation between lₑ and the EVM illustrated in FIG. 7 to be described later. Even with values other than this, the EVM can be improved by using this method.

In the symbol

$$k = {\overline{k}}_{0}$$

data in the delay direction outside an extraction region is extrapolated from extracted measurement data.

First, a model that extrapolates an amplitude of the CIR-RS response in an upper region in the delay index from data of

$${\overline{l}}_{0} + ⌈ {l}_{c} / 2 ⌉ \leq l \leq {\overline{l}}_{0} + ⌊ {l}_{e} / 2 ⌋$$

is obtained. The model uses a power function as follows.

$$[ Expression 1 ]$$

$${a}_{U} ( l ) = {α}_{1} {\{ mod ( l - {\overline{l}}_{0} - ⌊ \frac{{l}_{c}}{2} ⌋ , M ) \}}^{- {β}_{1}} + {γ}_{1} \qquad ( 1 )$$

Optimum values of parameters α₁, β₁, and γ₁ are obtained by fitting. Any one or more of α₁, β₁, and γ₁ may be fixed to an appropriate value, and the remaining parameters may be obtained by the fitting.

For example, the fitting parameter β₁ of Expression (1) may be fixed to 1. In a case where there is a fractional component with respect to a sampling timing in a propagation environment, an impulse-shaped signal spreads to the DD space even in a case where there is no multipath. Since an amplitude component of this spread decreases in inverse proportion to an index, higher accuracy may be obtained by fixing the fitting parameter β₁ to 1, for example, in a case where a noise component is large.

On the other hand, in the first example embodiment, β₁ is set as a free parameter in consideration of the fact that a power index changes by congestion with a multipath component of propagation.

In Expression (1), γ₁ is a floor component of an amplitude, and is considered to be approximately a noise component. Therefore, a value estimated from a noise amount of the reception signal may be fixed. In the first example embodiment, the floor component is set to be sufficiently small with respect to the amplitude of the CIR-RS, and is fixed to 0 to perform the fitting.

Remainder calculation is indicated by mod(a, b), and

$$a - b ⌊ a / b ⌋$$

holds.
└∩┘, ┌⋅┐
   represent rounding down and rounding up of decimal points.

Next, from data of

$${\overline{l}}_{0} - ⌊ {l}_{e} / 2 ⌋ \leq l \leq {\overline{l}}_{0} - ⌈ {l}_{c} / 2 ⌉$$

a model that complements an amplitude of the CIR-RS response in a lower region is obtained. The model is represented as follows.

$$[ Expression 2 ]$$

$${a}_{L} ( l ) = {α}_{2} {\{ mod ( {\overline{l}}_{0} - ⌊ \frac{{l}_{c}}{2} ⌋ - l , M ) \}}^{- {β}_{2}} + {γ}_{2} \qquad ( 2 )$$

Optimum values of parameters α₂, β₂, and γ₂ are obtained by fitting. Any one or more of α₂, β₂, and γ₂ may be fixed to an appropriate value, and the remaining parameters may be obtained by the fitting.

From Expressions (1) and (2), a model that extrapolates an amplitude on the outside of the CIR-RS response is obtained as follows by using a weighted average.

$$[ Expression 3 ]$$

$$a ( l ) = \frac{M - mod ( l - {\overline{l}}_{0} , M )}{M} {a}_{U} ( l ) + \frac{mod ( l - {\overline{l}}_{0} , M )}{M} {a}_{L} ( l ) \qquad ( 3 )$$

Next, by using phase data of

$${\overline{l}}_{0} + ⌈ {l}_{c} / 2 ⌉ \leq l \leq {\overline{l}}_{0} + ⌊ {l}_{e} / 2 ⌋ and$$

$${\overline{l}}_{0} - ⌊ {l}_{e} / 2 ⌋ \leq l \leq {\overline{l}}_{0} - ⌈ {l}_{c} / 2 ⌉$$

a model that extrapolates a phase of the CIR-RS response is obtained. The model is represented as follows.

$$[ Expression 4 ]$$

$$θ ( l ) = {α}_{3} mod ( l - {\overline{l}}_{0} - ⌊ \frac{{l}_{c}}{2} ⌋ , M ) + {β}_{3} \qquad ( 4 )$$

Optimum values of parameters α₃ and β₃ are obtained by fitting. One of α₃ and β₃ may be fixed to an appropriate value, and the remaining parameter may be obtained by the fitting.

The parameter α₃ is a slope of a phase change. The slope of the phase change of the impulse-shaped signal spread by the fractional propagation environment is calculated to be −π/M. Therefore, for example, the fitting may be performed while α₃=−π/M is fixed.

By using the received CIR-RS signal and Expressions (3) and (4), a CIR-RS response yk₀(l) using this method in the symbol
k̅₀
   is obtained as follows.

$$[ Expression 5 ]$$

$${y}_{k 0} ( l ) = \{ \begin{matrix}{y}_{0} ( l , {\overline{k}}_{0} ) , & {\overline{l}}_{0} - ⌊ \frac{{l}_{e}}{2} ⌋ \leq l \leq {\overline{l}}_{0} + ⌊ \frac{{l}_{e}}{2} ⌋ \\ a ( l ) {e}^{j θ ( l )} , & otherwise\end{matrix} \qquad ( 5 )$$

That is, an actual measurement value is used in the extracted data range, and the CIR-RS response is extrapolated using the model obtained above outside the extracted data range.

Next, CIR-RS responses in the symbols

$$k \neq {\overline{k}}_{0}$$

are obtained. In these symbols, changes in the amplitude and the phase from the symbol
k̅₀
   of the CIR-RS of the extracted data range are used. The changes in the amplitude and the phase are represented as follows.

$$\begin{matrix}[ Expression 6 ] & \\ {a}_{r} ( k ) = {\sum }_{l = {l}_{0} - ⌊ \frac{{l}_{c}}{2} ⌋}^{{l}_{c}} \vert {y}_{0} ( l , k ) \vert / {\sum }_{l = {l}_{0} - ⌊ \frac{{l}_{c}}{2} ⌋}^{{l}_{c}} \vert {y}_{0} ( l , {\overline{k}}_{0} ) \vert & ( 6 )\end{matrix}$$

$$\begin{matrix}[ Expression 7 ] & \\ ϕ ( k ) = arg [ {\sum }_{l = {l}_{0} - ⌊ {l}_{c} / 2 ⌋}^{{l}_{c}} \frac{{y}_{0} ( l , k )}{{y}_{0} ( l , {\overline{k}}_{0} )} ] & ( 7 )\end{matrix}$$

arg [⋅] represents the phase of.

Using Expressions (5), (6), and (7), a CIR-RS response of the entire one subframe is obtained as follows.

$$\begin{matrix}[ Expression 8 ] & \\ {y}_{e} ( l , k ) = {y}_{k 0} ( l ) {a}_{r} ( k ) {e}^{j ϕ ( k )} & ( 8 )\end{matrix}$$

A matrix having yₑ(l, k) as each element is set as Yₑ.

Yₑ is subjected to ISFFT transform by the ISFFT1 unit 305, and becomes a signal
[symbol] in the TF space.

Subsequent processing is the same as that of the method described in WO 2023/053472 A1.

A signal Xᵣ in the DD space in which only the CIR-RS signal is arranged is input to the ISFFT2 unit 306, and the signal Xᵣ is converted into a signal
[symbol] in the TF space.
[symbol] may be calculated in advance and stored in a memory.

A division unit calculates a quotient for each matrix element of
[symbol] and,
[symbol] and obtains a channel coefficient [symbol]
   of the TF space.

The first equalizer EQ1 (209) performs equalization processing by using a known method such as a Zero-Forcing method or a minimum mean square error method. A signal after the equalization processing is set as

[symbol]

In the signal

[symbol]

an error component that has not been removed by the EQ1 (209) may remain. The second equalizer EQ2 (211) removes the error component by using the PCRS.

In the above description, although omitted for simplicity, in a case where the value of the delay index becomes negative or exceeds M−1, folding is considered in such a way as to fall within the value of 0 to M−1. For example, in a case where l=M, data of l=0 is used. In a case where l=−1, data of l=M−1 is used. The same applies to the Doppler index.

### (Description of Effect of Wireless Communication Device of First Example Embodiment)

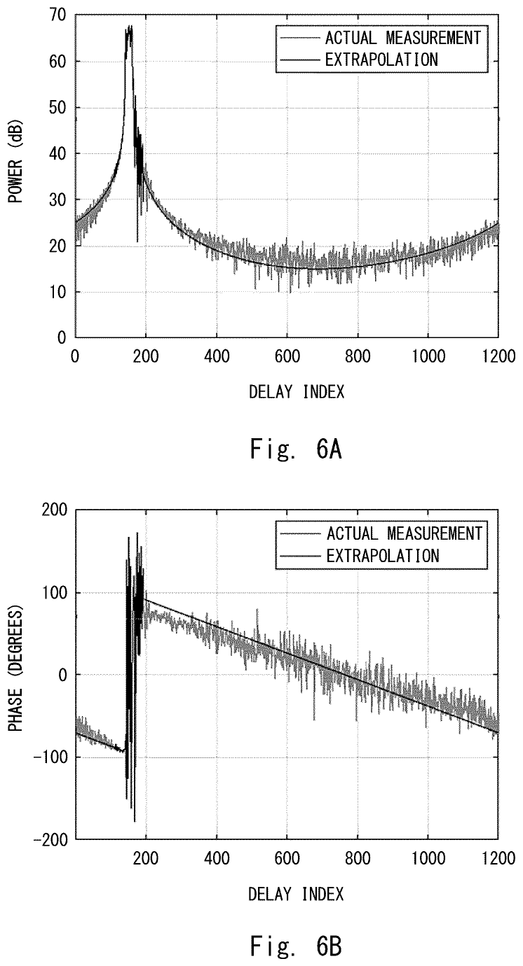

FIGS. 6A and 6B illustrate comparison between the amplitude and the phase that are modeled in the above method and a measurement result in the symbol
k̅₀. In this drawing, in order to confirm an effect, the OTFS signal in which only the CIR-RS signal is arranged without arranging the user data is used.

FIG. 6A illustrates the comparison of the amplitude, and FIG. 6B illustrates the comparison of the phase. A solid line indicates actual measurement, and a black solid line indicates the result yk₀(l) of the extrapolation.

Pieces of data used to model the extrapolation are

$${\overline{l}}_{0} + ⌈ {l}_{c} / 2 ⌉ \leq l \leq {\overline{l}}_{0} + ⌊ {l}_{e} / 2 ⌋ ( 159 \leq l \leq 189 ) \\ and \\ {\overline{l}}_{0} - ⌊ {l}_{e} / 2 ⌋ \leq l \leq {\overline{l}}_{0} - ⌈ {l}_{c} / 2 ⌉ ( 109 \leq l \leq 139 ) ,$$

and it can be seen that the extrapolation can be accurately performed to the outside.

FIG. 7 illustrates comparison of the EVM between a case where this extrapolation method is used (solid line) and a case where this extrapolation method is not used (broken line). The number of extracted subcarriers lₑ of the symbol
k̅₀
   is changed, and each EVM is measured.

In a case where this extrapolation is not used, a value of an element other than the extraction region is set to zero, and the channel estimation is performed.

In a case where the extrapolation is not performed, the EVM deteriorates as the extraction region becomes narrower. On the other hand, in a case where the extrapolation is performed, the EVM low to lₑ=about 80 can be maintained.

Therefore, it can be seen that, by using this method, the channel estimation can be accurately implemented from the narrow region, and the user data can be arranged in the region outside extraction.

In a case where the related extrapolation is not used, it is necessary to extract the CIR-RS from the wide range in order to obtain sufficient EVM, and the user data cannot be arranged in the extraction region.

As a result, a throughput is lowered in the related method, but the throughput can be improved by using this method.

(Description of Communication Control Method of Wireless Communication Device according to Second Example Embodiment)

In the first example embodiment, extrapolation is performed using the model in the delay direction. Similarly, extrapolation may be performed in the Doppler direction.

For extrapolation, aᵣ(k) and φ(k) in a range of

$${\overline{k}}_{0} - ⌊ {k}_{e} / 2 ⌋ \leq k \leq {\overline{k}}_{0} + ⌊ {k}_{e} / 2 ⌋$$

are used.

For an amplitude of a CIR-RS response of a symbol having a larger Doppler index than that of a symbol
k₀,
   aᵣ(k) of

$${\overline{k}}_{0} + 1 \leq k \leq {\overline{k}}_{0} + ⌊ {k}_{e} / 2 ⌋$$

is used, and modeling is performed with the following function.

$$\begin{matrix}[ Expression 9 ] & \\ {A}_{U} ( k ) = {α}_{4} {\{ mod ( k - {\overline{k}}_{0} , N ) \}}^{- {β}_{4}} + {γ}_{4} & ( 9 )\end{matrix}$$

Optimum values of parameters α₄, β₄, and γ₄ are obtained by fitting. Any one or more of α₄, β₄, and γ₄ may be fixed to an appropriate value, and the remaining parameters may be obtained by the fitting.

For an amplitude on a lower side with respect to
k₀,
   aᵣ(k) of

$${\overline{k}}_{0} - ⌊ {k}_{e} / 2 ⌋ \leq k \leq {\overline{k}}_{0} - 1$$

is used, and modeling is performed with the following function.

$$\begin{matrix}[ Expression 10 ] & \\ {A}_{L} ( k ) = {α}_{5} {\{ mod ( {\overline{k}}_{0} - k , N ) \}}^{- {β}_{5}} + {γ}_{5} & ( 10 )\end{matrix}$$

Optimum values of parameters α₅, β₅, and γ₅ are obtained by fitting. Any one or more of α₅, β₅, and γ₅ may be fixed to an appropriate value, and the remaining parameters may be obtained by the fitting.

An amplitude model A(k) used for the extrapolation is obtained by a weighted average of Expressions (9) and (10) as follows, similarly to the case of the delay index of the first example embodiment.

$$\begin{matrix}[ Expression 11 ] & \\ A ( k ) = \frac{N - mod ( k - {\overline{k}}_{0} , N )}{N} {A}_{U} ( k ) + \frac{mod ( k - {\overline{k}}_{0} , N )}{N} {A}_{L} ( k ) & ( 11 )\end{matrix}$$

A phase of the CIR-RS response is modeled by the following function by using φ(k) of

$$\begin{matrix}[ Expression 12 ] & \\ {\overline{k}}_{0} - ⌊ {k}_{e} / 2 ⌋ \leq k \leq {\overline{k}}_{0} + ⌊ {k}_{e} / 2 ⌋ . \\ Φ ( k ) = {α}_{6} mod ( k - {\overline{k}}_{0} , N ) + {β}_{6} & ( 12 )\end{matrix}$$

Optimum values of parameters α₆ and β₆ are obtained by fitting. One of α6 and β₆ may be fixed to an appropriate value, and the remaining parameter may be obtained by the fitting.

Using the amplitude obtained by Expressions (11) and (12) and the phase, a CIR-RS response of entire one subframe is obtained as follows.

$$\begin{matrix}[ Expression 13 ] & \\ {y}_{e} ( l , k ) = \{ \begin{matrix}{y}_{k 0} ( l ) {a}_{r} ( k ) {e}^{j ϕ ( k )} , & {\overline{k}}_{0} - ⌊ {k}_{e} / 2 ⌋ \leq k \leq {\overline{k}}_{0} + ⌊ {k}_{e} / 2 ⌋ \\ {y}_{k 0} ( l ) A ( k ) {e}^{j Φ ( k )} , & otherwise\end{matrix} & ( 13 )\end{matrix}$$

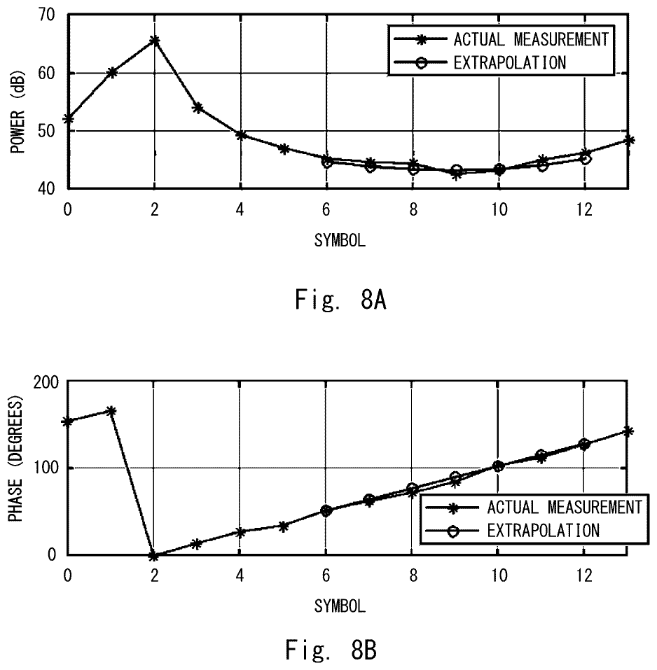

FIGS. 8A and 8B illustrate extrapolation results in a symbol direction. In FIGS. 8A and 8B, data measured at a carrier frequency of 28 GHz and given a frequency offset in a case where UE moves toward an AP at a speed of about 100 km/h is used. Therefore, a center position of a CIR-RS is shifted from k₀=1 to

$${\overline{k}}_{0} = 2 ,$$

and spreads greatly in a Doppler index direction.

In FIG. 8A, a asterisk indicates the amplitude αᵣ(k) of actual measurement, and a black circle indicates the extrapolated amplitude A(k). In FIG. 8B, a asterisk indicates the phase φ(k) of actual measurement, and a black circle indicates an extrapolated phase Φ(k). Here, since kₑ=7 is set, a range of

$$6 \leq k \leq 12$$

is extrapolated. It can be seen that the actual measurement can be accurately extrapolated by this method.

In the second example embodiment, since N=14 is set, it is difficult to see an effect, but in a case where N is set to a larger value, a larger effect is exhibited.

By this extrapolation in the Doppler direction, a size k_{g} of a guard space in the Doppler direction can be set to a value larger than kₑ and smaller than N. As a result, a space of a DD space in which user data can be arranged spreads, and a throughput is improved.

(Description of Communication Control Method of Wireless Communication Device according to Third Example Embodiment)

Since data is arranged in a DD space in an OTFS, it is possible to accurately obtain a relative speed v to a communication target. A calculation unit obtains the relative speed to the communication target.

In a case where UE is not moving with respect to an AP, it is considered appropriate to regard that all pieces of data of symbols other than a symbol k₀ in which a CIR-RS is arranged are zero.

A CIR-RS response in a case where the third example embodiment is applied to the first example embodiment will be described below.

$$\begin{matrix}[ Expression 14 ] & \\ {y}_{e} ( l , k ) = \{ \begin{matrix}0 , & k \neq {k}_{0} and v < {v}_{li m} \\ {y}_{k 0} ( l ) , & otherwise\end{matrix} , & ( 14 )\end{matrix}$$

A threshold Vₗᵢₘ is set to about 1 km/h in consideration of a measurement error.

As a result, in a case where the UE is stationary or a movement speed is sufficiently slow, an influence of noise can be reduced and channel estimation can be accurately performed.

(Description of Communication Control Method of Wireless Communication Device according to Fourth Example Embodiment)

In the first and second example embodiments, the power function is used to extrapolate the amplitude of the CIR-RS, but other functions may be used. For example, modeling may be performed by Rayleigh distribution.

In general, it is known that a multipath is distributed in the Rayleigh distribution, and there is a case where extrapolation can be performed more accurately by performing modeling by using this.

However, since fitting calculation becomes more complicated than the power function, it can be considered that an amount of calculation increases.

(Description of Communication Control Method of Wireless Communication Device according to Fifth Example Embodiment)

In the first to fourth example embodiments, the outer component of the CIR-RS is extrapolated, and the channel estimation accuracy is improved and the guard space is reduced. On the other hand, by reducing the guard space, modulation accuracy is likely to decrease due to leakage of a CIR-RS component to a user data region.

Therefore, the CIR-RS component obtained by extrapolation may be subtracted from a signal of the user data region.

As a result, interference of the CIR-RS component with user data can be suppressed, and high modulation accuracy can be obtained.

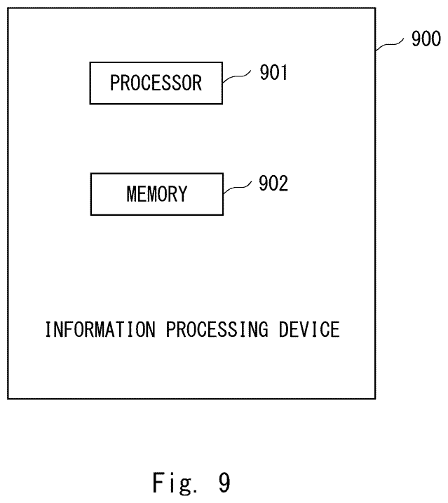

The above communication control method is executed by an information processing device. FIG. 9 is a block diagram illustrating a configuration of an information processing device 900. The information processing device 900 includes a processor 901 that executes a program and performs processing, and a memory 902 that stores the program. The information processing device 900 may include one device or a plurality of devices. The information processing device 900 may be a cloud server that processes some or all of functions in a distributed manner.

A part or all of the processing in the information processing device 900 described above can be achieved as a computer program. Such a program can be stored and supplied to a computer by using various types of non-transitory computer-readable media. The non-transitory computer-readable media include various types of tangible recording media. Examples of the non-transitory computer-readable media include a magnetic recording medium (for example, a flexible disk, a magnetic tape, or a hard disk drive), a magneto-optical recording medium (for example, a magneto-optical disc), a compact disc read only memory (CD-ROM), a CD-R, a CD-R/W, and a semiconductor memory (for example, a mask ROM, a programmable ROM (PROM), an erasable PROM (EPROM), a flash ROM, or a random access memory (RAM)). The program may be supplied to the computer by using various types of transitory computer-readable media. Examples of the transitory computer-readable media include electric signals, optical signals, and electromagnetic waves. The transitory computer-readable medium can supply the program to the computer via a wired communication path such as an electric wire and an optical fiber or a wireless communication path.

Such a program can also be referred to as a communication control program.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Some or all of the example embodiments described above may also be described as, but are not limited to, the following Supplementary Notes.

### (Supplementary Note 1)

A wireless communication device including:
a memory that stores a program; and
a processor that processes the program that
receives an orthogonal time frequency space (OTFS) signal from a communication target,
estimates an entire spread of a pilot signal of the OTFS signal by using data near a center of the pilot signal,
extrapolates a reference signal (channel impulse response reference signal (CIR-RS)) by using a result of the estimation, and
performs channel estimation with the extrapolated signal.

### (Supplementary Note 2)

The wireless communication device according to Supplementary Note 1, in which the extrapolation is performed in a delay direction or a Doppler direction.

### (Supplementary Note 3)

The wireless communication device according to Supplementary Note 1, in which the processor performs processing of obtaining a relative speed to the communication target.

### (Supplementary Note 4)

The wireless communication device according to Supplementary Note 1, in which the extrapolation uses a power function or Rayleigh distribution.

### (Supplementary Note 5)

The wireless communication device according to Supplementary Note 1, in which, in the performing the channel estimation, a CIR-RS component obtained by the extrapolation is subtracted from a signal of a user data region.

### (Supplementary Note 6)

A wireless communication system including:
a communication target that transmits an orthogonal time frequency space (OTFS) signal; and
a wireless communication device including: a memory that stores a program; and a processor that processes the program that receives the OTFS signal from the communication target, estimates an entire spread of a pilot signal of the OTFS signal by using data near a center of the pilot signal, extrapolates a reference signal (channel impulse response reference signal (CIR-RS)) by using a result of the estimation, and performs channel estimation with the extrapolated signal.

### (Supplementary Note 7)

The wireless communication system according to Supplementary Note 6, in which the extrapolation is performed in a delay direction or a Doppler direction.

### (Supplementary Note 8)

The wireless communication system according to Supplementary Note 6, in which the processor performs processing of obtaining a relative speed to the communication target.

### (Supplementary Note 9)

A communication control method including:
receiving an orthogonal time frequency space (OTFS) signal from a communication target;
estimating an entire spread of a pilot signal of the OTFS signal by using data near a center of the pilot signal;
extrapolating a reference signal (CIR-RS) by using a result of the estimation; and
performing channel estimation with the extrapolated signal.

### (Supplementary Note 10)

A non-transitory computer-readable medium storing a communication control program for causing an information processing device to execute:
receiving an orthogonal time frequency space (OTFS) signal from a communication target;
estimating an entire spread of a pilot signal of the OTFS signal by using data near a center of the pilot signal;
extrapolating a reference signal (CIR-RS) by using a result of the estimation; and
performing channel estimation with the extrapolated signal.

Some or all of the elements (for example, configurations and functions) described in Supplementary Notes 2 to 5 dependent on Supplementary Note 1 {e.g. device} can also be dependent on Supplementary Notes 6 {e.g. system}, 9 {e.g. method}, and 10 {e.g. non-transitory computer-readable medium} by the same dependency relationship as Supplementary Notes 2 to 5. Some or all of the elements described in any Supplementary Note can be applied to various types of hardware, software, recording means for recording software, systems, and methods.

What is claimed is:

1. A wireless communication device comprising:
a memory configured to store instructions; and
a processor configured to execute the instructions to:
receive an orthogonal time frequency space (OTFS) signal from a communication target,
estimate an entire spread of a pilot signal of the OTFS signal by using data near a center of the pilot signal,
extrapolate a reference signal (channel impulse response reference signal (CIR-RS)) by using a result of the estimation, and
perform channel estimation with the extrapolated signal.

2. The wireless communication device according to claim 1, wherein the extrapolation is performed in a delay direction or a Doppler direction.

3. The wireless communication device according to claim 1, wherein the processor is configured to execute the instructions to obtain a relative speed to the communication target.

4. The wireless communication device according to claim 1, wherein the extrapolation uses a power function or Rayleigh distribution.

5. The wireless communication device according to claim 1, wherein, in the performing the channel estimation, a CIR-RS component obtained by the extrapolation is subtracted from a signal of a user data region.

6. A wireless communication system comprising:
a communication target configured to transmit an orthogonal time frequency space (OTFS) signal; and
a wireless communication device including:
a memory configured to store instructions; and
a processor configured to execute the instructions to:
receive the OTFS signal from the communication target, estimate an entire spread of a pilot signal of the OTFS signal by using data near a center of the pilot signal, extrapolate a reference signal (channel impulse response reference signal (CIR-RS)) by using a result of the estimation, and perform channel estimation with the extrapolated signal.

7. The wireless communication system according to claim 6, wherein the extrapolation is performed in a delay direction or a Doppler direction.

8. The wireless communication system according to claim 6, wherein the processor is configured to execute the instructions to obtain a relative speed to the communication target.

9. The wireless communication system according to claim 6, wherein the extrapolation uses a power function or Rayleigh distribution.

10. The wireless communication system according to claim 6, wherein, in the performing the channel estimation, a CIR-RS component obtained by the extrapolation is subtracted from a signal of a user data region.

11. A communication control method comprising:
receiving an orthogonal time frequency space (OTFS) signal from a communication target;
estimating an entire spread of a pilot signal of the OTFS signal by using data near a center of the pilot signal;
extrapolating a reference signal (CIR-RS) by using a result of the estimation; and
performing channel estimation with the extrapolated signal.

12. The communication control method according to claim 11, wherein the extrapolation is performed in a delay direction or a Doppler direction.

13. The communication control method according to claim 11, comprising obtaining a relative speed to the communication target.

14. The communication control method according to claim 11, wherein the extrapolation uses a power function or Rayleigh distribution.

15. The communication control method according to claim 11, wherein, in the performing the channel estimation, a CIR-RS component obtained by the extrapolation is subtracted from a signal of a user data region.

16. A non-transitory computer-readable medium storing a communication control program for causing an information processing device to execute the communication control method according to claim 11.
